(19) United States
(12) Patent Application Publication
(10) Pub. No.: US 2003/0139914 A1
(43) Pub. Date: Jul. 24, 2003

(54) Electromagnetic field intensity calculating method and apparatus

(75) Inventors: Takashi Yamagajo, Kawasaki (JP); Kenji Nagase, Kawasaki (JP); Shinichi Ohtsu, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/151,110

(22) Filed: May 21, 2002

(30) Foreign Application Priority Data
Jan. 24, 2002 (JP) 2002-015671

(51) Int. Cl. G06G 7/48

(52) U.S. Cl. 703/5; 703/14

(57) ABSTRACT

An independent current source and a voltage-dependent source are arranged at each of ports, and a voltage at each of the ports is calculated with a circuit analysis. A voltage source is arranged at each of the ports by using the calculated voltage value, and a current flowing in an analysis target is calculated with an electromagnetic wave analysis. An analysis time is incremented stepwise, and the calculation of the voltage at each of the ports and the calculation of the current flowing in the analysis target are repeated. As a result, an electromagnetic field intensity calculation can be made with high accuracy even for an analysis target where a plurality of ports exists between a circuit analysis model and an electromagnetic wave analysis model.

### BACKGROUND OF THE INVENTION

1. Field of the Invention

The present invention relates to a method calculating the intensity of an electromagnetic field produced by an electromagnetic wave radiated from an electronic appliance, etc., and more particularly, to an electromagnetic field intensity calculating method and apparatus making an analysis by separating an analysis target which includes a nonlinear circuit component into a circuit analysis model, an electromagnetic wave analysis model, and a plurality of ports linking the two models.

2. Description of the Related Art

As a technique simulating an electromagnetic wave radiated from an electronic appliance, there are a variety of electromagnetic wave analysis techniques such as a moment method, and the like. With the moment method, an analysis is made by partitioning a printed circuit board, a metal plate, etc. of an electronic appliance into plane elements called patches, or by partitioning, for example, an antenna into line elements called wires.

When an analysis of an electromagnetic wave radiated from an electronic appliance which includes a nonlinear circuit component, etc. is made, it must be made by combining an electromagnetic wave analysis and a circuit analysis. The following document is disclosed as an analysis method that is implemented by combining an electromagnetic wave analysis and a circuit analysis as described above.

Document 1) J. A. Landt, “Network loading of thin-wire antennas and scatters in the time domain”, Radio Science, vol. 16, pp. 1241-1247, 1981

According to this document, an analysis is made by combining an electromagnetic wave analysis method called a time domain moment method and a circuit analysis method. This analysis is made for an analysis target, the antenna of which is connected to a circuit network, by partitioning a wire as the antenna into a plurality of linear segments, and by generating an equation of n elements for an unknown antenna current which flows in each of the segments, and an equation of m elements for a current which flows in the circuit network.

If an electromagnetic wave analysis and a circuit analysis are combined as described above, an analysis is normally made by separating an analysis target into a circuit analysis model which includes a nonlinear circuit component, an electromagnetic wave analysis model configured by wires, patches, etc., and a port as a portion linking the two models. According to Document 1, an analysis is made by being limited to the case of only one port, a system represented by simultaneous equations of n plus m elements is simplified into a problem that can be solved independently for two systems of n and m elements, an antenna current is obtained, and an electromagnetic wave analysis is made.

As another technique implemented by combining a a circuit analysis method and an electromagnetic wave analysis method, there is a technique realized by combining a FDTD (Finite Difference Time Domain) electromagnetic field analysis method and a circuit analysis method. Such techniques are disclosed by the following documents.

Document 2) Japanese Patent Publication No. 11-153634 “Simulation Device and a Computer-readable Storage Medium Storing a Simulation Program”

Document 3) Japanese Patent Publication No. 2000-330973 “Hybrid Analysis Method Combining a FDTD Electromagnetic Field Analysis Method and a Transient Electric Circuit Analysis Method, and a Hybrid FDTD Electromagnetic Field-Transient Electric Circuit Analysis Apparatus”

With the above described time domain moment method, a model itself is partitioned as in the case where an antenna is partitioned into segments, an electric current flowing in the model is obtained, and an electric or a magnetic field is calculated based on the obtained current. In the meantime, with the FDTD method, space including a model is partitioned into blocks, and an electromagnetic field in the space is directly obtained without obtaining an electric current.

Document 2 discloses a simulation device that combines an electromagnetic wave analysis and a circuit analysis. With this device, an electric field value (an electric field value of a domain where a circuit exists) based on the circuit analysis is passed to the electromagnetic wave analysis when a time of the circuit analysis approaches a time at which the electric field must be obtained, so that a difference is reduced between the time at which the passed electric field value is obtained and the time at which the electric field is obtained with the electromagnetic wave analysis by reflecting the electric field value, and a stable analysis result can be obtained.

Document 3 discloses a hybrid analysis method and apparatus implemented by combining a FDTD method and a TECA (Transient Electric Circuit Analysis) method.

As described above, several techniques implemented by combining an electromagnetic wave analysis and a circuit analysis are proposed as techniques for simulating an electromagnetic wave radiated from an electronic appliance that includes a nonlinear circuit component such as a diode, etc. However, Document 1 has a problem that this technique is only applicable to the case of only one port as a portion linking a circuit analysis model and an electromagnetic wave analysis model, and an analysis target where a plurality of ports exists between two models cannot be handled.

Additionally, the techniques implemented by combining a FDTD method and a circuit analysis like Documents 2 and 3 partition space which includes a model into blocks. Therefore, for instance, if an electromagnetic field at a point apart 100 meters from a model is obtained, space including up to that point must be partitioned into blocks, leading to an increase in the amount of calculation.

Additionally, space is partitioned into blocks. Accordingly, for an analysis target including a line element such as a dipole antenna, a spiral antenna, etc., it is difficult to partition the antenna itself into blocks. As a result, sufficient calculation accuracy cannot be obtained.

### SUMMARY OF THE INVENTION

An object of the present invention is to provide an electromagnetic field intensity calculating method and apparatus that can analyze a radiated electromagnetic wave with high accuracy even for an analysis target where a plurality of ports exist as linking portions between an electromagnetic wave analysis model and a circuit analysis model, in view of the above described problems.

An electromagnetic field intensity calculating method according to the present invention, which calculates an electromagnetic field produced by an electromagnetic wave radiated from an analysis target by separating the analysis target that includes a nonlinear circuit component into a circuit analysis model to which a circuit analysis method is to be applied, an electromagnetic wave analysis model to which an electromagnetic field analysis method is to be applied, and a plurality of ports as portions linking the two models, comprises: arranging an independent current source and a voltage-dependent current source at each of the plurality of ports, and calculating a voltage at each of the plurality of ports; arranging a voltage source at each of the plurality of ports by using the calculated voltage value, and calculating a current flowing in the analysis target with an electromagnetic wave analysis; and incrementing an analysis time stepwise, and repeating the calculation of the voltage at each of the plurality of ports and the calculation of the current flowing in the analysis target.

An electromagnetic field intensity calculating apparatus according to the present invention, which calculates an electromagnetic field produced by an electromagnetic wave radiated from an analysis target by separating the analysis target that includes a nonlinear circuit component into a circuit analysis model to which a circuit analysis method is to be applied, an electromagnetic wave analysis model to which an electromagnetic wave analysis method is to be applied, and a plurality of ports as portions linking the two models, comprises: a circuit analyzing unit arranging an independent current source and a voltage-dependent current source at each of the plurality of ports, and calculating a voltage at each of the plurality of ports with the circuit analysis; a current calculating unit arranging a voltage source at each of the plurality of ports by using the calculated voltage value, and calculating a current flowing in the analysis target with the electromagnetic wave analysis; and a repeated calculation controlling unit incrementing an analysis time stepwise, and repeating the calculation of the voltage at each of the plurality of ports and the calculation of the current flowing in the analysis target.

According to the present invention, a calculation of an electromagnetic field can be made with high accuracy by arranging a current source or a voltage source at each of a plurality of ports between a circuit analysis model and an electromagnetic wave analysis model, and by obtaining a time change in a current flowing in the models while alternately repeating an electromagnetic wave analysis and a circuit analysis.

### BRIEF DESCRIPTION OF THE DRAWINGS

FIG. 1 is a functional block diagram showing the principle of the present invention;

FIG. 2 explains an analysis target where an electromagnetic wave analysis model and a circuit analysis model are combined, according to a preferred embodiment;

FIG. 3 explains the model configuration in the case where a time domain moment method is used for the electromagnetic wave analysis model in the analysis target in FIG. 2;

FIG. 4 explains an analysis target model obtained by replacing the time domain moment method model with current sources;

FIG. 5 explains an analysis target model obtained by replacing the circuit analysis model with voltage sources;

FIG. 6 is a flowchart showing an electromagnetic field calculation process;

FIG. 7 is a flowchart showing the electromagnetic field calculation process (continued);

FIG. 8 explains a model where a dipole antenna is connected to a circuit;

FIG. 9 explains a model in the case where a circuit analysis is made to the model shown in FIG. 8;

FIG. 10 explains an analysis model in a simulation;

FIG. 11 shows a result of a simulation made for the model shown in FIG. 10; and

FIG. 12 explains the loading of a program according to the preferred embodiment into a computer.

### DESCRIPTION OF THE PREFERRED EMBODIMENTS

Hereinafter, a preferred embodiment according to the present invention is described in detail with reference to the drawings.

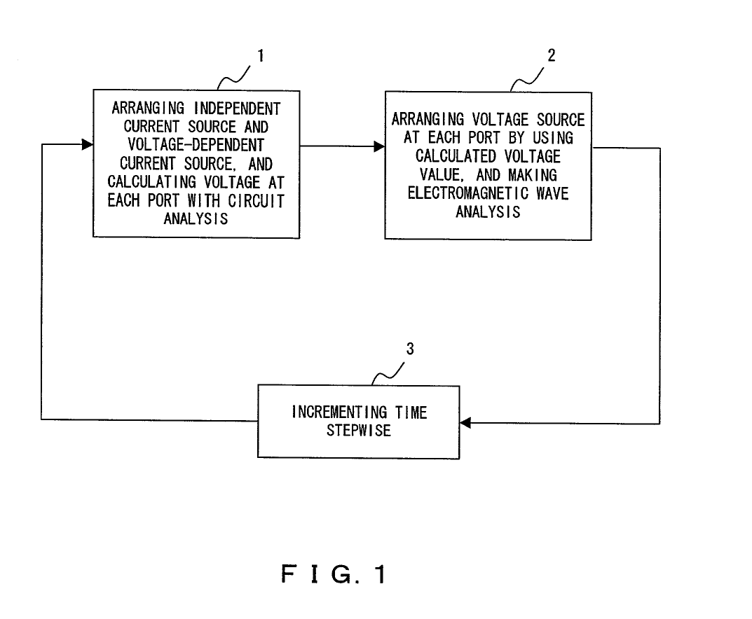

FIG. 1 is a functional block diagram showing the principle of an electromagnetic field intensity calculating method according to the present invention. This figure shows the principle of the electromagnetic field intensity calculating method that calculates the intensity of an electromagnetic field produced by an electromagnetic wave radiated from an analysis target by separating the analysis target which includes a nonlinear circuit component into a circuit analysis model to which a circuit analysis method is to be applied, an electromagnetic wave analysis model to which an electromagnetic wave analysis method is to be applied, and a plurality of ports as portions linking the two models.

In FIG. 1, firstly in 1, an independent current source and a voltage-dependent current source are arranged at each of the plurality of ports, and a voltage at each of the plurality of ports is calculated with a circuit analysis. In 2, a voltage source is arranged at each of the plurality of ports by using the calculated voltage value, and a current flowing in the analysis target is calculated with an electromagnetic wave analysis. In 3, an analysis time is incremented stepwise, and the calculation of the voltage at each of the plurality of ports in 1, and the calculation of the current flowing in the analysis target in 2 are repeated.

In the preferred embodiment according to the present invention in FIG. 1, a modification node analysis method and a time domain moment method can be respectively used as a circuit analysis method and an electromagnetic wave analysis method.

In the preferred embodiment according to the present invention in FIG. 1, an analysis target is partitioned into minute elements prior to a voltage calculation made with a circuit analysis in order to apply a time domain moment method. As a result, the above described voltage-dependent current source settings can be made by using part of elements of an admittance matrix which includes admittances between the minute elements as elements, or the above described independent current source settings can be made by calculating a value of a current flowing in each of the plurality of ports in the state where a voltage is applied none of the plurality of ports, and by using the calculated current value.

Additionally, in the preferred embodiment according to the present invention in FIG. 1, it is possible to obtain an electromagnetic field radiated from an analysis target by using the above described calculation result of the current flowing in the analysis target, and to obtain an electromagnetic field in a frequency region, which is radiated from the analysis target, by converting the current flowing in the analysis target into a value in the frequency region and by using the current value after being converted.

Furthermore, an electromagnetic field intensity calculating apparatus according to the present invention comprises: a circuit analyzing unit arranging an independent current source and a voltage-dependent current source at each of the plurality of ports as portions linking a circuit analysis model and an electromagnetic wave analysis model, and calculating a voltage at each of a plurality of ports with a circuit analysis; an electromagnetic wave analyzing unit arranging a voltage source at each of the plurality of ports with the calculated voltage value, and calculating a current flowing in the analysis target with an electromagnetic wave analysis by; and a repeated calculation controlling unit incrementing an analysis time stepwise, and respectively making the circuit analyzing unit and the electromagnetic wave analyzing unit perform the calculation of the voltage at each of the plurality of ports and the calculation of the current flowing in the analysis target.

A program, which is used by a computer calculating an electromagnetic field intensity, causing the computer to execute a process, the process comprising: arranging an independent current source and a voltage-dependent current source at each of the plurality of ports, and calculating a voltage at each of a plurality of ports with a circuit analysis; arranging a voltage source at each of the plurality of ports with the calculated voltage value, and calculating a current flowing in an analysis target with an electromagnetic wave analysis; and incrementing an analysis time stepwise, and repeating the calculation of the voltage at each of the plurality of ports and the calculation of the current flowing in the analysis target.

Used as a storage medium according to the present invention is a computer-readable portable storage medium on which is recorded a program for causing a computer to execute a process, the process comprising: calculating a voltage at each of a plurality of ports with a circuit analysis by arranging an independent current source and a voltage-dependent current source at each of the plurality of ports; calculating a current flowing in an analysis target with an electromagnetic wave analysis by arranging a voltage source at each of the plurality of ports with the calculated voltage value; and incrementing an analysis time stepwise, and repeating the calculation of the voltage at each of the plurality of ports and the calculation of the current flowing in the analysis target.

As described above, a current source or a voltage source is arranged at each of a plurality of ports between a circuit analysis model and an electromagnetic wave analysis model, a time change in a current flowing in the models is obtained while alternately repeating an electromagnetic wave analysis and a circuit analysis, so that an electromagnetic field is calculated.

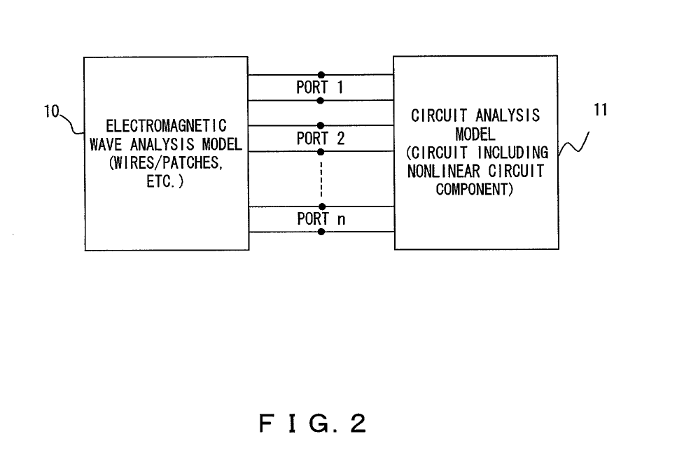

FIG. 2 shows the configuration of models whose electromagnetic intensities are to be calculated in a preferred embodiment according to the present invention. As shown in this figure, an analysis target is configured by an electromagnetic wave analysis model 10, which is partitioned into wires, patches, etc. and becomes a target of an electromagnetic wave analysis, a circuit analysis model 11 such as an electronic circuit including a nonlinear circuit component such as a diode, and a plurality of ports as portions linking the two models, n ports in this case.

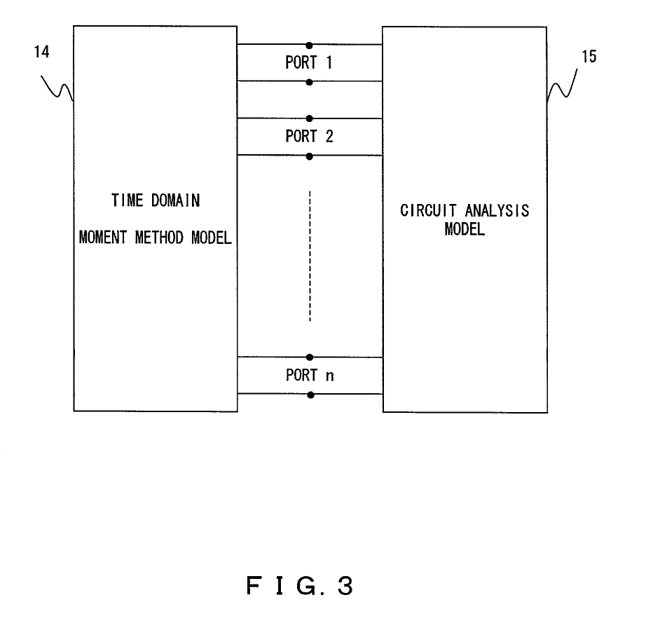

FIG. 3 explains an analysis method applied to the analysis target model explained with reference to FIG. 2. As shown in this figure, the electromagnetic wave analysis model 10 and the circuit analysis model 11, which are shown in FIG. 2, are respectively represented as a time domain moment method model 14 to be analyzed with a time domain moment method and a circuit analysis model 15 to be analyzed, for example, with SPICE (Simulation Program with Integrated Circuit Emphasis), namely, a modified nodal analysis method, and the two models are assumed to be linked by n ports.

As described above, in this preferred embodiment, an analysis is made by combining the time domain moment method as an electromagnetic wave analysis method, and the circuit analysis. The analysis made with the time domain moment method is first outlined. With the time domain moment method, a model of an analysis target is partitioned into minute elements such as patches, wires, etc., and a current flowing in each of the minute elements is set, for example, as I₁(t), I₂(t), . . . Iₘ(t) if it is assumed that the number of minute elements is m.

Hereinafter, a character representing a vector is underscored in symbol notation of such as “matrix”, “vector”, “component”, “solution to an equation”, “current”, “voltage”, etc. in this specification.

Next, a solution I(t) to the following linear simultaneous equations is obtained by using a matrix Z representing the mutual impedance between minute elements, a vector I(t) representing a current flowing in each of the minute elements, a vector V(t) representing a voltage applied to each of the plurality of ports in FIG. 3, and a time delay component Re (t).

ZI(t)=Re(t)+V(t) (1)

Here, the matrix Z is a matrix of m rows and m columns, the vectors I(t) and V(t) are m-dimensional vectors having m components. The component of V(t) is a voltage applied to each of the plurality of ports. The value of a component of V, which corresponds to a current flowing in a minute element that is not connected to a port, is set to 0 as will be described later, whereas the value of a component of V, which corresponds to a current flowing in a minute element that is connected to a port, becomes a value of the voltage applied to the connected port.

The time delay component Re(t) is also called a retarded component. If a current flows in each minute element partitioned with a time domain moment method, it radiates an electric field for a different minute element with a delay of the amount of time obtained by dividing the distance between minute elements by light velocity. The component corresponding to the voltage by this electric field is Re(t).

Lastly, an electromagnetic field produced by the current I(t) flowing in a minute element is calculated, and the analysis made with the time domain moment method is terminated.

A method combining the time domain moment method and the circuit analysis method is described next.

Here, assume that an analysis target model as a time domain moment method model is partitioned into m minute elements as described above, and each of n (n≦m) elements among the m minute elements is connected to any one of the n ports.

Firstly, the above provided equation (1) is obtained in correspondence with the time domain moment method model. In the equation (1), it is assumed that values other than the current I(t), and the voltage V(t) applied to each of the plurality of ports are known.

Next, if an input from each port is not made, namely, if a port is not connected, the following equation is satisfied by setting the vector V(t) of a voltage applied to each minute element to 0.

ZIᵤ(t)=Re(t) (2)

Here, Iᵤ(t) is a vector whose component is a current flowing in each minute element of the time domain moment method model in the case where a port is not connected. Supposing that the inverse matrix of the mutual impedance matrix Z is an admittance matrix Y, the following equation is satisfied.

Iᵤ(t)=YRe(t) (3)

A current flowing in an ith minute element among the m minute elements becomes an ith row in the equation (3), and is provided by the following equation.

$${I}_{ui} ( t ) = {\sum }_{j = 1}^{m} {Y}_{ij} {Re}_{j} ( t ) \qquad ( 4 )$$

Here, a current flowing in a different port is calculated when a voltage is applied to each of the ports. When a voltage V¹ is applied to a port 1, a current flowing in the ith minute element that is connected to a kth port is given by the following equation. This current corresponds to a current in the case where the time delay component Re(t) is not considered in the equation (1).

$${I}_{pi}^{k} ( t ) = {\sum }_{l = 1}^{n} {Y}^{kl} {V}^{l} \qquad ( 5 )$$

Y^{kl} in the above provided equation corresponds to an admittance between the ith minute element that is connected to the kth port and the port l, when a voltage is applied to the port l. This admittance makes a one-to-one correspondence with an element Yᵢⱼ of the admittance matrix Y in the time domain moment method model. Namely, it should be noted that Y^{kl} and Yᵢⱼ are equal in the case where an i(j)th minute element of the time domain moment method model is connected to a k(l)th element.

If the time delay component Re(t) is considered, a current flowing in the ith minute element is a sum of the current given by the equation (5) and the current of the time delay component, and is given by the following equation.

$$\begin{matrix}{I}_{i}^{k} ( t ) = {\sum }_{j = 1}^{m} {Y}_{ij} {Re}_{j} ( t ) + {\sum }_{l = 1}^{n} {Y}^{kl} {V}^{l} \\ = {I}_{ui}^{k} ( t ) + {I}_{pi}^{k} ( t )\end{matrix} \qquad ( 6 )$$

If the ith element is connected none of the ports, the current flowing in that element only corresponds to the time delay component, and is given by the following equation.

$${I}_{t} ( t ) = {\sum }_{j = 1}^{m} {Y}_{ij} {Re}_{j} ( t ) = {I}_{ui} ( t ) \qquad ( 7 )$$

If the equations (6) and (7) are represented with matrices and vectors, the following equations (8) and (9) are obtained.

I(t)=YRe(t)+YV(t) (8)

I(t)=Iᵤ(t)+YV(t) (9)

If the equation (9) is written in the form of a matrix, a matrix of currents flowing in respective minute elements is given by the following equation.

$$( \begin{matrix}{I}_{1} \\ {I}_{2} \\ ⋮ \\ ⋮ \\ ⋮ \\ ⋮ \\ {I}_{m}\end{matrix} ) = ( \begin{matrix}{I}_{u1} \\ {I}_{u2} \\ ⋮ \\ ⋮ \\ ⋮ \\ ⋮ \\ {I}_{um}\end{matrix} ) + ( \begin{matrix}{Y}_{11} & {Y}_{12} & ⋯ & ⋯ & ⋯ & ⋯ & {Y}_{1 m} \\ {Y}_{21} & {Y}_{22} & & & & & {Y}_{2 m} \\ ⋮ & & ⋰ & & & & ⋮ \\ ⋮ & & & ⋰ & & & ⋮ \\ ⋮ & & & & ⋰ & & ⋮ \\ ⋮ & & & & & ⋰ & ⋮ \\ {Y}_{m1} & {Y}_{m2} & ⋯ & ⋯ & ⋯ & ⋯ & {Y}_{m m}\end{matrix} ) ( \begin{matrix}{V}^{1} \\ {V}^{2} \\ ⋮ \\ ⋮ \\ ⋮ \\ ⋮ \\ {V}^{m}\end{matrix} ) \qquad ( 10 )$$

In the equation (10), the value of an applied voltage is assigned only to a component corresponding to a minute element that is connected to a port among minute elements corresponding to each row for each of components V¹ to V^{m} of the vector V on the right side, and the values of the other components of the vector V are set to 0. Also the elements of the matrix Y other than the element corresponding to the Y^{k1} in the equation (6) become 0.

If the ith minute element of the time domain moment method model is connected to the kth port as described above, a current Iᵢ^{k}(t) flowing in the ith element is determined by n voltage-dependent current sources Y^{k1}V¹, which are respectively controlled by Iᵤₗ^{k}(t) as an independent current source and a voltage V¹ applied to each port.

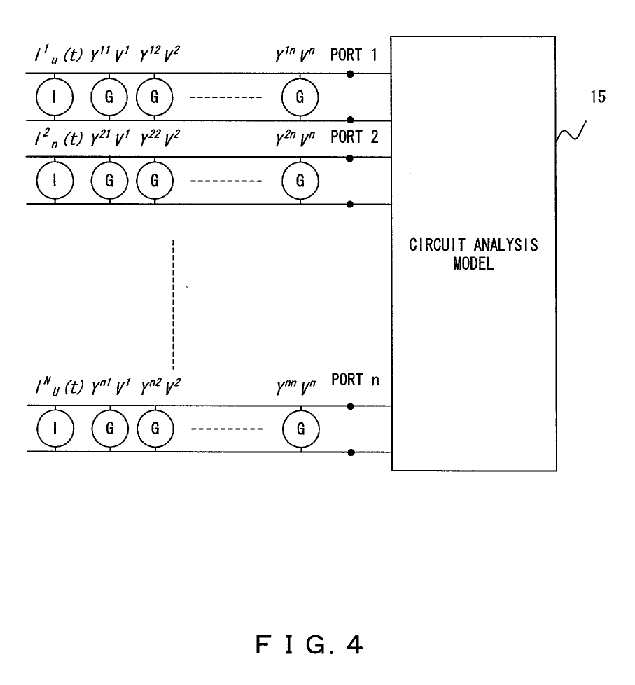

FIG. 4 explains a model obtained by replacing the time domain moment method model with current sources connected to respective ports in accordance with the above described consideration way. In this figure, for example, Iᵤⁿ(t) as an independent current source I and n voltage-dependent current sources Yⁿ¹V¹ to YⁿⁿVⁿ as voltage-dependent current source Gs are connected to a port n. Here, the independent current source Iᵤⁿ(t) corresponds to the first term Iᵤᵢ^{k}(t) on the right side of the equation (6). However, since “i” of the ith minute element connected to the kth port is unknown in FIG. 4, a subscript is only u.

For a circuit analysis such as a circuit analysis using SPICE, the model shown in FIG. 4 is solved with the circuit analysis method, so that Vⁿ(t) as a node voltage at each port is obtained.

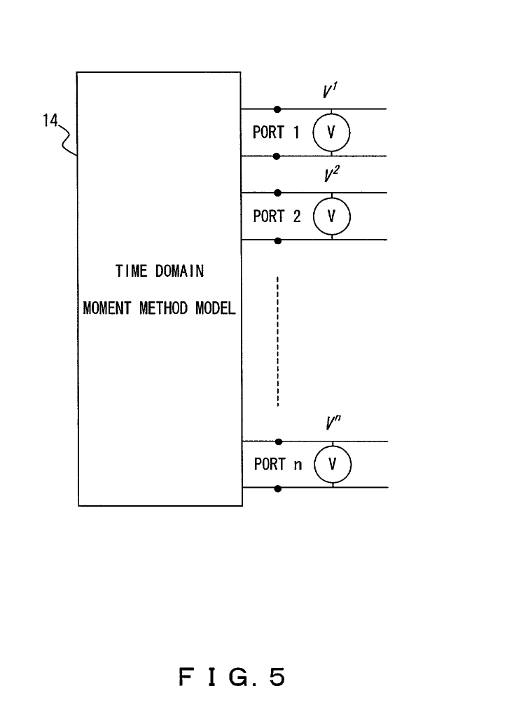

FIG. 5 explains a model implemented by replacing the circuit analysis model with voltage sources by using node voltages at respective ports, which are obtained as described above. V connected to each port is an independent voltage source, and its value is given by the node voltages V¹ to Vⁿ at the respective ports, which are obtained with the circuit analysis in FIG. 4. Then, an analysis is made with a time domain moment method by using the model shown in FIG. 5, and a vector I(t) whose components are currents I₁(t), I₂(t), . . . , Iₘ(t), which respectively flow in m minute elements, is obtained.

If the currents flowing in the minute elements are obtained in this way, an electromagnetic field can be obtained with a known method. This method is briefly described. Firstly, an electric field E is obtained with the following equation.

E=−gradφ−divA (11)

An electromagnetic field H is obtained with the following equation.

μH=rotA (12)

In these equations, φ indicates a scalar potential, and A indicates a vector potential. The scalar potential φ is determined by a distribution of an electric charge q of a model. q and a current J flowing in the model are related to each other by the following equation of continuity.

$$div \underline{J} = - \frac{\partial q}{\partial t} \qquad ( 13 )$$

Accordingly, if a current distribution is learned, the electric charge q can be obtained. For the vector potential A, the following equations are satisfied by using a free-space Green's function G.

for line elements A=∫JGdl (14)

for plane elements A= [symbol] JGdS (15)

The equation (14) corresponds to line elements, and integration is made according to the line elements. The equation (15) corresponds to plane elements, and integration is made for the entire surface of a model. If a current flowing in a model is learned as described above, an electromagnetic field can be calculated.

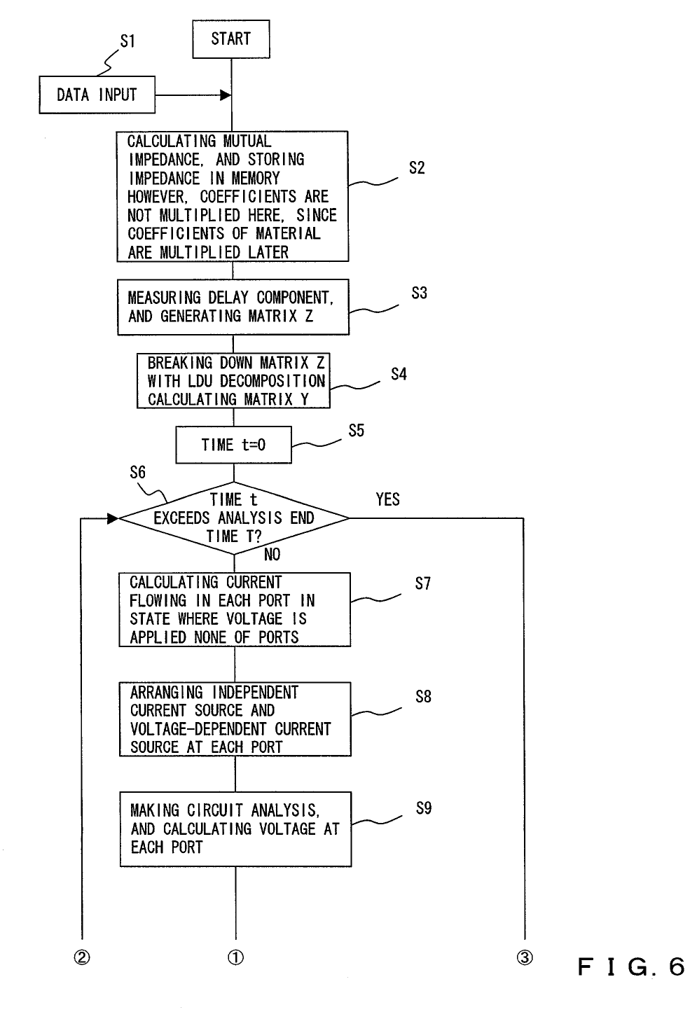

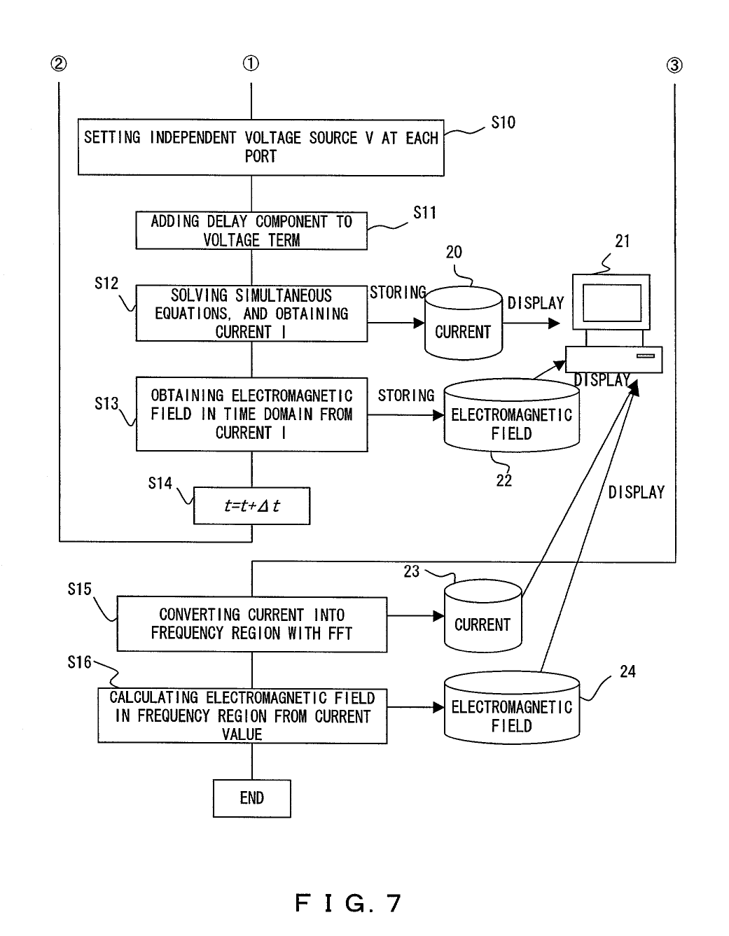

FIGS. 6 and 7 are flowcharts showing an analysis process performed in this preferred embodiment. Once the process is started in FIG. 6, data input is first made in step S1. The input data includes an analysis step width as shared data, namely, a time interval to be described later, component and node information as circuit analysis data, and port information indicating which port is connected to which node within a circuit.

Analysis data of the time domain moment method includes information about the position, the size and the material of a minute element configuring a model, and port information indicating which port is connected to which minute element.

As a result of the data input in step S1, a time interval and an analysis end time are read from the input data with a data read routine, and stored in memory not shown. Additionally, the position, the size and the electric characteristic of each minute element are stored in the memory in correspondence with the time domain moment method, and element and node information are stored in the memory in correspondence with the circuit analysis.

A mutual impedance is calculated in step S2 of FIG. 6, and stored in the memory. However, shared coefficients of a material, such as permeability, electric permittivity, etc. are not multiplied here. Then, in step S3, a delay component is determined, and an impedance matrix Z is generated. Operations in steps S2 and S3 are performed by a matrix generation routine of the time domain moment method. A matrix of mutual impedances between minute elements is generated based on the position data of minute elements, a time delay component is determined and excluded from the matrix, and a matrix of impedances, namely, Z is generated.

Then, in step S4, the impedance matrix Z is broken down with LDU decomposition, and an admittance matrix, namely, a matrix Y is calculated. This calculation is made by a matrix computation routine, and each element of the matrix is stored in the memory.

After an analysis time t is set to an initial value 0 in step S5, an electromagnetic field analysis process at each analysis time is performed. Firstly, it is determined whether or not the value of the time t becomes larger than the analysis end time T in step S6. Here, it is determined that the value of the time t does not become larger than the analysis end time T, and the process goes to step S7.

In step S7, a calculation of a current which flows in each of ports in the case where a voltage is applied none of the ports is made. This calculation is made with a current calculation routine of the time domain moment method. The result of this calculation is provided to a circuit analysis routine.

Steps S8 and S9 are operations performed by the circuit analysis routine. In step S8, an independent current source and a voltage-dependent current source are arranged at a port according to the current value which is obtained by the current calculation routine, and the admittance matrix Y which is obtained by the matrix computation routine. In step S9, a calculation of a voltage at each of the ports by the circuit analysis, namely, the voltage between ports is calculated by the circuit analysis routine, for example, with representative circuit analysis software SPICE based on the calculation of the voltage at each port, which is made with the circuit analysis, namely, the current source arranged at each port, and the node and component information provided from the input data.

Operations in steps S10 to S13 are operations performed by the current calculation routine of the time domain moment method. In this routine, the time delay component Re(t) is already calculated from time data and the position data of minute elements. In step S10, independent voltage sources are set as described with reference to FIG. 5.

In step S11, the time delay component is added to the voltage term. In step S12, simultaneous matrix equations (8) and (9), which use the voltage applied to a port, the time delay component, and the admittance matrix Y, are solved, so that a current vector I is obtained, and a current flowing in each minute element is stored in a current file 20 and displayed on a screen of a terminal 21 depending on need.

Then, in step S13, an electromagnetic field in a time domain is obtained by using the current vector I, and its result is stored in an electromagnetic field file 22, and displayed on the screen of the terminal 21. After the value of the time t is incremented by a time interval Δt in step S14, the operations in and after step S6 are repeated.

If it is determined that the analysis time t exceeds the analysis end time T in step S6, the current in the time domain is converted into a value in a frequency region by a FFT (Fast Fourier Transform) routine instep S15, and its result is stored in a current file 23, and displayed on the screen of the terminal 21. Additionally, in step S16, an electromagnetic field in the frequency region is calculated from the current value in the frequency region by the electromagnetic field calculation routine in step S16, and its result is stored in an electromagnetic field file 24 and displayed on the screen of the terminal 21. Here, the process is terminated.

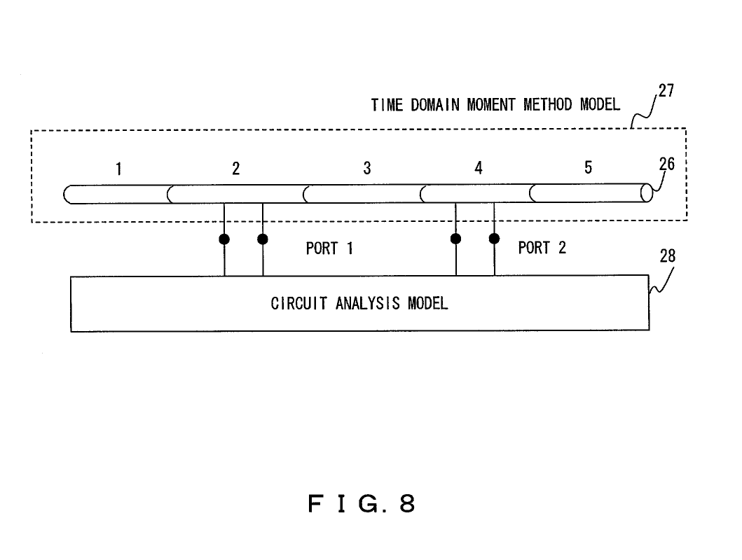

Next, a specific example to which the analysis method according to this preferred embodiment is applied is described. FIG. 8 shows an analysis model of an analysis target where a dipole antenna is connected to a circuit. This figure assumes that the dipole antenna 26 is partitioned into 5 minute elements (wires) as a time domain moment method model 27, and connected to a circuit analysis model 28 by respectively connecting the second and the fourth minute elements to the first and the second ports.

Currents flowing in the respective minute elements are represented by the following matrices.

$$\begin{matrix}( \begin{matrix}{I}_{1} \\ {I}_{2} \\ {I}_{3} \\ {I}_{4} \\ {I}_{5}\end{matrix} ) = ( \begin{matrix}{Y}_{11} & {Y}_{12} & {Y}_{13} & {Y}_{14} & {Y}_{15} \\ {Y}_{21} & {Y}_{22} & {Y}_{23} & {Y}_{24} & {Y}_{25} \\ {Y}_{31} & {Y}_{32} & {Y}_{33} & {Y}_{34} & {Y}_{35} \\ {Y}_{41} & {Y}_{42} & {Y}_{43} & {Y}_{44} & {Y}_{45} \\ {Y}_{51} & {Y}_{52} & {Y}_{53} & {Y}_{54} & {Y}_{55}\end{matrix} ) ( \begin{matrix}{Re}_{1} \\ {Re}_{2} \\ {Re}_{3} \\ {Re}_{4} \\ {Re}_{5}\end{matrix} ) + ( \begin{matrix}0 & 0 & 0 & 0 & 0 \\ 0 & {Y}^{11} & 0 & {Y}^{12} & 0 \\ 0 & 0 & 0 & 0 & 0 \\ 0 & {Y}^{21} & 0 & {Y}^{22} & 0 \\ 0 & 0 & 0 & 0 & 0\end{matrix} ) ( \begin{matrix}0 \\ {V}^{1} \\ 0 \\ {V}^{2} \\ 0\end{matrix} ) & ( 16 ) \\ = ( \begin{matrix}{Y}_{11} & {Y}_{12} & {Y}_{13} & {Y}_{14} & {Y}_{15} \\ {Y}_{21} & {Y}_{22} & {Y}_{23} & {Y}_{24} & {Y}_{25} \\ {Y}_{31} & {Y}_{32} & {Y}_{33} & {Y}_{34} & {Y}_{35} \\ {Y}_{41} & {Y}_{42} & {Y}_{43} & {Y}_{44} & {Y}_{45} \\ {Y}_{51} & {Y}_{52} & {Y}_{53} & {Y}_{54} & {Y}_{55}\end{matrix} ) ( \begin{matrix}{Re}_{1} \\ {Re}_{2} \\ {Re}_{3} \\ {Re}_{4} \\ {Re}_{5}\end{matrix} ) + ( \begin{matrix}0 & 0 & 0 & 0 & 0 \\ 0 & {Y}_{22} & 0 & {Y}_{24} & 0 \\ 0 & 0 & 0 & 0 & 0 \\ 0 & {Y}_{42} & 0 & {Y}_{44} & 0 \\ 0 & 0 & 0 & 0 & 0\end{matrix} ) ( \begin{matrix}0 \\ {V}^{1} \\ 0 \\ {V}^{2} \\ 0\end{matrix} ) & \\ = ( \begin{matrix}{I}_{u1} \\ {I}_{u2} ( = {I}_{u2}^{1} ) \\ {I}_{u3} \\ {I}_{u4} ( = {I}_{u4}^{2} ) \\ {I}_{u5}\end{matrix} ) + ( \begin{matrix}0 & 0 & 0 & 0 & 0 \\ 0 & {Y}_{22} & 0 & {Y}_{24} & 0 \\ 0 & 0 & 0 & 0 & 0 \\ 0 & {Y}_{42} & 0 & {Y}_{44} & 0 \\ 0 & 0 & 0 & 0 & 0\end{matrix} ) ( \begin{matrix}0 \\ {V}^{1} \\ 0 \\ {V}^{2} \\ 0\end{matrix} ) & \end{matrix}$$

Here, since the second and the fourth minute elements are respectively connected to the first and the second ports as shown in FIG. 8, it should be noted that the relationships represented by the following equations are satisfied.

Y¹¹=Y₂₂, Y¹²=Y₂₄, Y²¹=Y₄₂, Y²²=Y₄₄

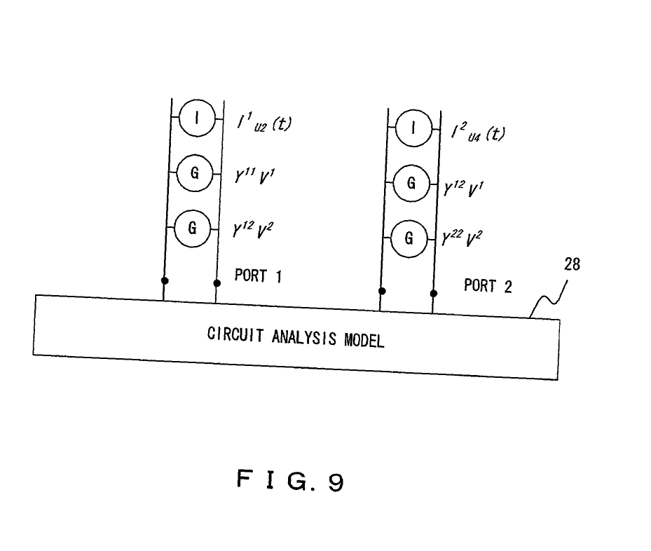

FIG. 9 shows a model obtained by replacing the time domain moment method model corresponding to FIG. 8 with independent current sources and voltage-dependent current sources, namely, the model equivalent to FIG. 4. similar to FIG. 4, one independent current source and two voltage-dependent current sources are respectively arranged at ports 1 and 2, and a circuit analysis is made by using this model.

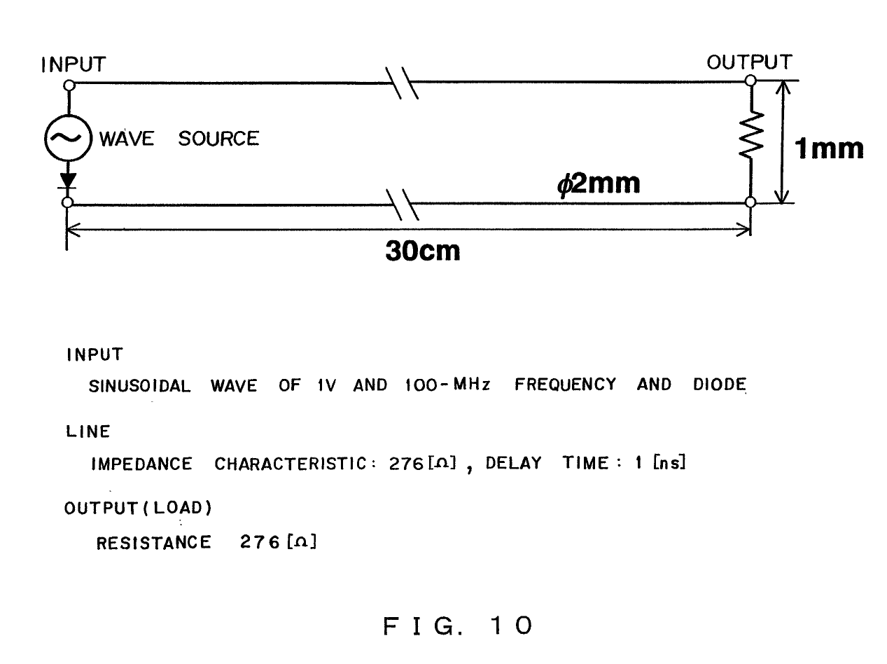

A simulation example according to this preferred embodiment is described next. FIG. 10 explains an analysis model in a simulation. In this figure, a wave source of a sinusoidal wave of 1V and a 100-MHz frequency, and a diode are connected to an input terminal, and a resistance of 276Ω for making a matching with a transmission line is connected to an output terminal. It is assumed that the input and the output terminals are connected by a transmission line the length of which is 30 cm, and the impedance characteristic of this transmission line is 276Ω, and a delay time is 1 ns.

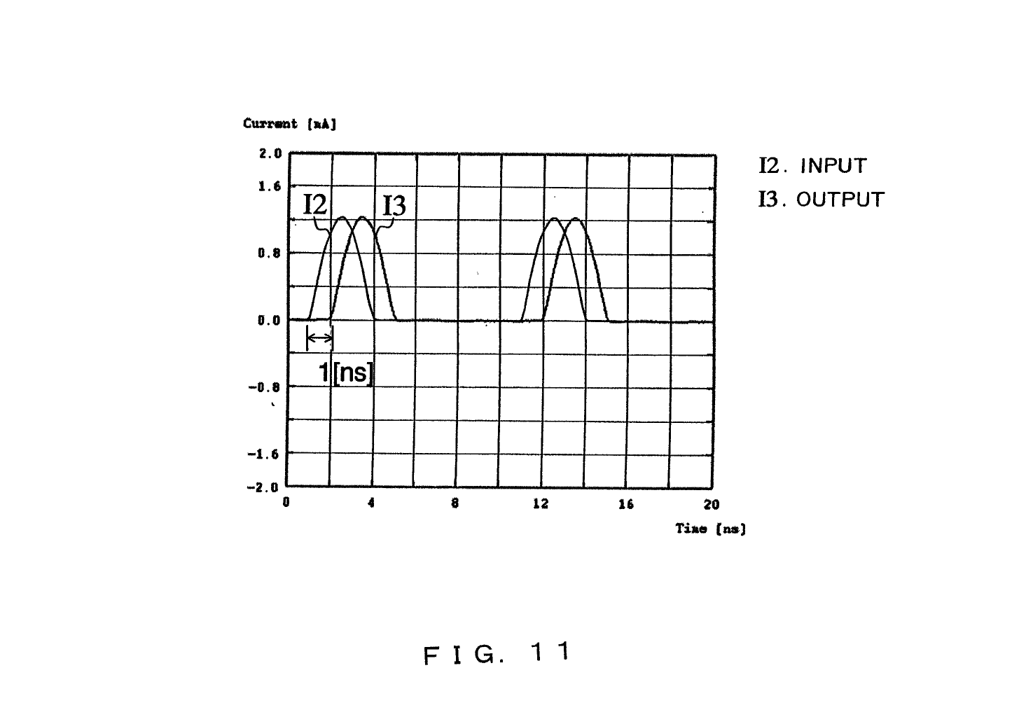

FIG. 11 shows a time change in an input/output current as a result of an analysis made for the analysis model shown in FIG. 10. In this figure, I2 and I3 respectively indicate input and output currents, and the diode is connected to the input terminal. Therefore, this figure shows, as a correct analysis result, a result such that both the input and the output currents are formed to be half-wave, and the output current is delayed by 1 ns from the input current. The width of the current (half-wave) waveform is approximately 3 ns, which is shorter than the half-cycle (5 ns) of a 100-MHz alternating current. This is because the power supply voltage is 1V, and a time period during which a current does not flow due to the forward voltage of the diode exists.

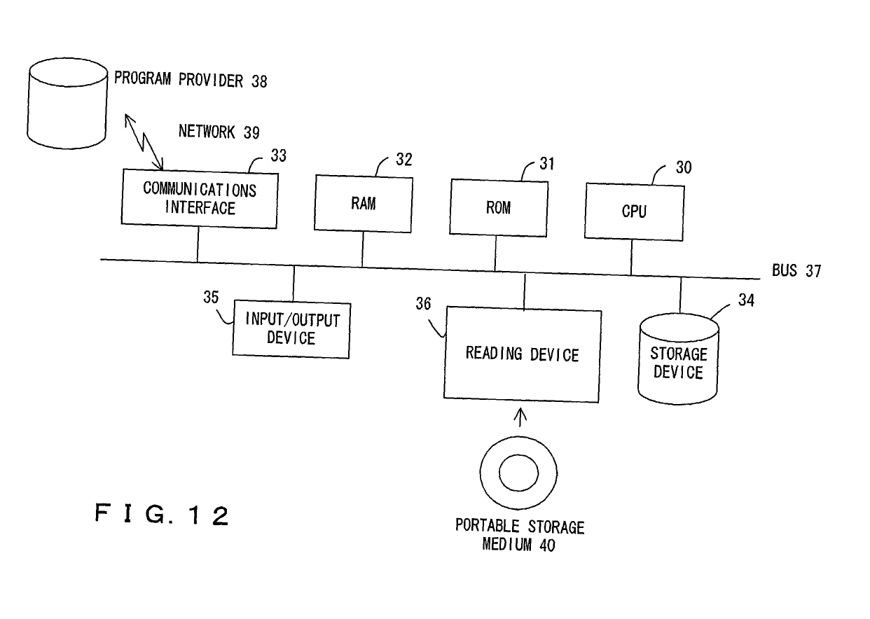

Up to this point, details of the electromagnetic field intensity calculating method according to the present invention are described. As a matter of course, an electromagnetic field intensity calculating apparatus implementing this method can be configured as a general computer system. FIG. 12 is a block diagram showing the configuration of such a computer system, namely, hardware environment.

In FIG. 12, the computer system is configured by a central processing unit (CPU) 30, read-only memory (ROM) 31, random access memory (RAM) 32, a communications interface 33, a storage device 34, an input/output device 35, and a portable storage medium reading device 36, which are interconnected by a bus 37.

As the storage device 34, a storage device in a variety of forms such as a hard disk, a magnetic disk, etc. is available. The program represented by the flowcharts shown in FIGS. 6 and 7 is stored in such a storage device 34 or the ROM 31. Such a program is executed by the CPU 30, so that it becomes possible to make an electromagnetic field calculation of an analysis target where a plurality of ports exist between a circuit analysis model and an electromagnetic analysis model as in the above described preferred embodiment.

Such a program can be stored, for example, in the storage device 34 via a network 39 and the communications interface 33 from a program provider 38 side, or can be stored onto a marketed and distributed portable storage medium 40, set by the reading device 36, and read and executed by the CPU 30. As the portable storage medium 40, a storage medium in a variety of forms such as a CD-ROM, a flexible disk, an optical disk, a magneto-optical disk, etc. is available. The program stored onto such a storage medium is read by the reading device 36, so that the electromagnetic field intensity calculation according to this preferred embodiment can be implemented.

As described in detail above, according to the present invention, an electromagnetic field produced by an electromagnetic wave radiated from an analysis target can be calculated in the case where the analysis target is configured by an electromagnetic wave analysis model, a circuit analysis model, and a plurality of ports linking the two models.

Furthermore, a time domain moment method is used as an electromagnetic wave analysis, so that an electromagnetic field can be calculated with high accuracy even for an analysis target in which an antenna such as a dipole antenna or a spiral antenna is connected to a circuit. This greatly contributes to an improvement in the practicability of an electromagnetic field intensity calculating apparatus.

What is claimed is:

1. An electromagnetic field intensity calculating method calculating an electromagnetic field produced by an electromagnetic wave radiated from an analysis target by separating the analysis target which includes a nonlinear circuit component into a circuit analysis model to which a circuit analysis method is to be applied, an electromagnetic wave analysis model to which an electromagnetic wave analysis method is to be applied, and a plurality of ports as portions linking the two models, comprising:
arranging an independent current source and a voltage-dependent current source at each of the plurality of ports, and calculating a voltage at each of the plurality of ports with the circuit analysis;
arranging a voltage source at each of the plurality of ports by using the calculated voltage value, and calculating a current flowing in the analysis target with the electromagnetic wave analysis; and
incrementing an analysis time stepwise, and repeating the calculation of the voltage at each of the plurality of ports and the calculation of the current flowing in the analysis target.

2. The electromagnetic field intensity calculating method according to claim 1, wherein
a modified nodal analysis method is used as the circuit analysis method.

3. The electromagnetic field intensity calculating method according to claim 1, wherein
a time domain moment method is used as the electromagnetic wave analysis method.

4. The electromagnetic field intensity calculating method according to claim 3, further comprising:
partitioning the analysis target into minute elements prior to the voltage calculation made with the circuit analysis in order to apply the time domain moment method; and
setting the voltage-dependent current source by using part of elements of an admittance matrix which has admittances between minute elements as elements.

5. The electromagnetic field intensity calculating method according to claim 1, further comprising:
calculating a current flowing in each of the plurality of ports in a state where a voltage is applied to none of the plurality of ports, prior to the voltage calculation made with the circuit analysis; and
setting the independent current source by using the calculated current value.

6. The electromagnetic field intensity calculating method according to claim 1, further comprising
obtaining an electromagnetic field radiated from the analysis target by using a result of the calculation of the current flowing in the analysis target, and obtaining the electromagnetic field also in the repeated calculations.

7. The electromagnetic field intensity calculating method according to claim 1, further comprising:
converting the current flowing in the analysis target, which is obtained in a time domain, into a value in a frequency region after the repeated calculations; and
obtaining an electromagnetic field in the frequency region, which is radiated from the analysis target, by using the current value after being converted.

8. An electromagnetic field intensity calculating apparatus, which calculates an electromagnetic field produced by an electromagnetic wave radiated from an analysis target by separating the analysis target that includes a nonlinear circuit component into a circuit analysis model to which a circuit analysis method is to be applied, an electromagnetic wave analysis model to which an electromagnetic wave analysis method is to be applied, and a plurality of ports as portions linking the two models, comprising:
a circuit analyzing unit arranging an independent current source and a voltage-dependent current source at each of the plurality of ports, and calculating a voltage at each of the plurality of ports with the circuit analysis;
a current calculating unit arranging a voltage source at each of the plurality of ports by using the calculated voltage value, and calculating a current flowing in the analysis target with the electromagnetic wave analysis; and
a repeated calculation controlling unit incrementing an analysis time stepwise, and repeating the calculation of the voltage at each of the plurality of ports, which is made by said circuit analyzing unit, and the calculation of the current flowing in the analysis target, which is made by said current calculating unit.

9. A program, which is used by a computer calculating an electromagnetic field produced by an electromagnetic wave radiated from an analysis target by separating the analysis target that includes a nonlinear circuit component into a circuit analysis model to which a circuit analysis method is to be applied, an electromagnetic wave analysis model to which an electromagnetic wave analysis method is to be applied, and a plurality of ports as portions linking the two models, causing the computer to execute a process, the process comprising:
arranging an independent current source and a voltage-dependent current source at each of the plurality of ports, and calculating a voltage at each of the plurality of ports with the circuit analysis;
arranging a voltage source at each of the plurality of ports by using the calculated voltage value, and calculating a current flowing in the analysis target with the electromagnetic wave analysis; and
incrementing an analysis time stepwise, and repeating the calculation of the voltage at each of the plurality of ports and the calculation of the current flowing in the analysis target.

10. A computer-readable storage medium, used by a computer calculating an electromagnetic field produced by an electromagnetic wave radiated from an analysis target by separating the analysis target that includes a nonlinear circuit component into a circuit analysis model to which a circuit analysis method is to be applied, an electromagnetic wave analysis model to which an electromagnetic wave analysis method is to be applied, and a plurality of ports as portions linking the two models, on which is recorded a program for causing the computer to execute a process, the process comprising:
arranging an independent current source and a voltage-dependent current source at each of the plurality of ports, and calculating a voltage at each of the plurality of ports with the circuit analysis;
arranging a voltage source at each of the plurality of ports by using the calculated voltage value, and calculating a current flowing in the analysis target with the electromagnetic wave analysis; and
incrementing an analysis time stepwise, and repeating the calculation of the voltage at each of the plurality of ports and the calculation of the current flowing in the analysis target.

11. An electromagnetic field intensity calculating apparatus, which calculates an electromagnetic field produced by an electromagnetic wave radiated from an analysis target by separating the analysis target that includes a nonlinear circuit component into a circuit analysis model to which a circuit analysis method is to be applied, an electromagnetic wave analysis model to which an electromagnetic wave analysis method is to be applied, and a plurality of ports as portions linking the two models, comprising:
circuit analyzing means for arranging an independent current source and a voltage-dependent current source at each of the plurality of ports, and for calculating a voltage at each of the plurality of ports with the circuit analysis;
current calculating means for arranging a voltage source at each of the plurality of ports by using the calculated voltage value, and for calculating a current flowing in the analysis target with the electromagnetic wave analysis; and
repeated calculation controlling means for incrementing an analysis time stepwise, and for repeating the calculation of the voltage at each of the plurality of ports, which is made by said circuit analyzing means, and the calculation of the current flowing in the analysis target, which is made by said current calculating means.
